(19) United States
(12) Patent Application Publication
(10) Pub. No.: US 2018/0118159 A1
(43) Pub. Date: May 3, 2018

(54) SYSTEM FOR CAR ALARM ALERT

(71) Applicants: Sawyer Jensen, Boulder, WY (US); Corey Jensen, Boulder, WY (US)

(72) Inventors: Sawyer Jensen, Boulder, WY (US); Corey Jensen, Boulder, WY (US)

(21) Appl. No.: 15/335,543

(22) Filed: Oct. 27, 2016

(51) Int. Cl. B60R 25/102; B60R 25/104

(52) U.S. Cl. CPC B60R 25/102; B60R 25/104

(57) ABSTRACT

A system for car alarm notification that includes: a vehicle alarm; a key; and a detachable FOB, where the detachable FOB is adapted for placement onto the key and wirelessly connected to a vehicle alarm; and an alarm alert integrated within the FOB. The alarm alert is preferably a light, where the light is adapted for flashing notification. The alarm alert also includes an audible sound.

### BACKGROUND OF THE INVENTION

### Field of Invention

The present invention relates to a system to alert a user of an active car alarm.

### Description of Related Art

Many vehicles include anti-theft alarms to secure the vehicle while parked and left unattended. Many times these vehicle alarms activate upon locking a vehicle's doors and the principle feature of most vehicle alarms is a blaring loud alarm should someone tamper with the vehicle in a manner associated with a theft. This loud audible alarm is easily detected and provides a deterrent for car theft. The alarm may startle a potential theft and prevent them from actively pursuing the theft and further alerts the user that theft may be taking place. Generally, the car alarm is an effective means to prevent vehicle theft. However, one drawback is occasionally the vehicle may be parked outside of the audible sound distance for a user or owner. In such a case, the vehicle alarm although sounding it does not properly alert a user that the vehicle alarm has been tripped. It would therefore be advantageous to have a further device that could be implemented with a vehicle alarm that provides a visual and audible alert when the user is outside the audible distance for the conventional auto alarm.

### SUMMARY OF THE INVENTION

The present invention relates to a system for car alarm notification that includes: a vehicle alarm; a key; and a detachable FOB, where the detachable FOB is adapted for placement onto the key and wirelessly connected to a vehicle alarm; and an alarm alert integrated within the FOB. The alarm alert is preferably a light, where the light is adapted for flashing notification. The alarm alert also includes an audible sound.

### BRIEF DESCRIPTION OF DRAWINGS

FIG. 1 depicts a system to alert of a car alarm activation in accordance with the present invention.

### DETAILED DESCRIPTION

The present invention relates to a system for a vehicle alarm notification that includes a detachable FOB. The detachable FOB according to present invention attaches to a traditional key so that a user may attach the FOB to a traditional key and therefore keep the FOB in a user's pocket. This particular key FOB according to present invention is integrated with the vehicle alarm so that upon activation of vehicle alarm the key FOB is also activated. The key FOB according to the present invention includes a flashing light and an audible sound. Upon activation of the vehicle alarm the light of the FOB according to present invention flashes and an audible alarm is emitted therefore notifying the user of a car alarm activation.

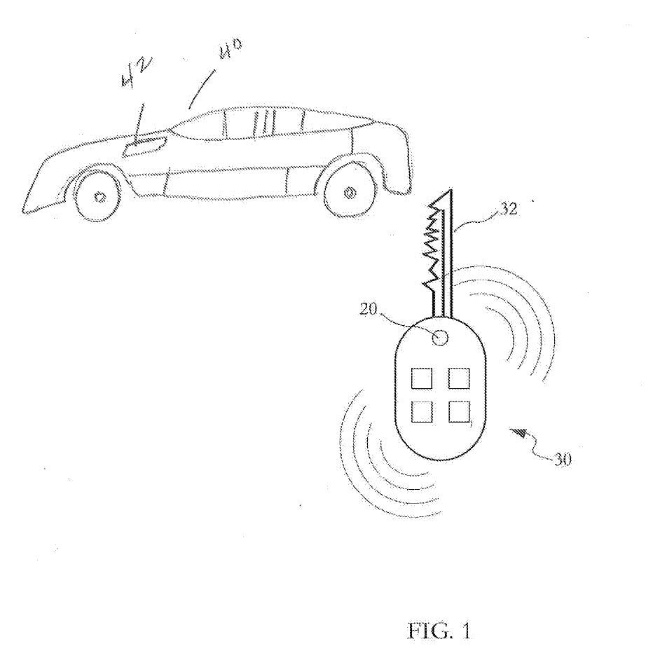

In reference to FIG. 1, a detachable FOB 30 in accordance with present invention is depicted. The detachable FOB 30 is attached to a key 32 as show in FIG. 1. The FOB 30 further includes a flashing light 20 that flashes upon activation of an integrated vehicle alarm. An audible sound is also emitted from the FOB 30 upon activation of the vehicle alarm. The FOB 30 is powered through a battery not shown within the FOB and is electronically integrated with a vehicle alarm so that it functions in the car operation with the alarm.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. An alarm notification system for a vehicle comprising:
a vehicle alarm;
a key; and
a detachable FOB, where the detachable FOB is adapted for placement onto the key and wirelessly connected to the vehicle alarm; and
an alarm alert integrated within the FOB.

2. The alarm notification system according to claim 1 where the alarm alert is a light.

3. The alarm notification system according to claim 2 where the light is adapted for flashing notification.

4. The alarm notification system according to claim 1 where the alarm alert includes an audible sound.
